(19) United States
(12) Patent Application Publication
(10) Pub. No.: US 2011/0166966 A1
(43) Pub. Date: Jul. 7, 2011

(54) Sharing Assets Across Applications

(75) Inventor: Nathon O.M. Gunn, Toronto (CA)

(73) Assignee: SOCIAL GAME UNIVERSE INC., TORONTO (CA)

(21) Appl. No.: 12/978,252

(22) Filed: Dec. 23, 2010

Related U.S. Application Data
(60) Provisional application No. 61/311,769, filed on Mar. 8, 2010.
(60) Provisional application No. 61/289,903, filed on Dec. 23, 2009.

(51) Int. Cl. G06Q 10/00

(52) U.S. Cl. 705/28

(57) ABSTRACT

A system and method allows for display to a user assets from a plurality of applications as well as sharing and creation of assets across multiple applications thereby facilitating interaction between users of the multiple applications.

### RELATED APPLICATIONS

This application claims the benefit of earlier field provisional applications U.S. App. No. 61/289,903 filed Dec. 23, 2009 and U.S. App. No. 61/311,769 filed Mar. 8, 2010, both of which are hereby incorporated by reference in their entirety for all purposes.

### BACKGROUND

1. Field of Art

The present disclosure is directed to interactions between users of multiple on-line applications.

2. Description of the Art

Interaction between users of the internet has developed and now takes place in a myriad of applications including social networking sites, on-line games, etc. In such applications, users have identities, objects and other assets but these cannot necessarily be moved between applications.

### BRIEF DESCRIPTION OF THE DRAWINGS

FIG. 1 is a high-level block diagram of a computer.

FIG. 2A illustrates a system architecture according to one embodiment.

FIG. 2B is a view of the asset server components related to user management of assets according to one embodiment.

FIG. 2C is a view of the asset server components related to developer management of assets according to one embodiment.

FIGS. 3A-3D illustrate display of assets to users according to various embodiments.

FIG. 4 is a flow chart illustrating the display of assets to a user and interaction with an asset.

FIG. 5 illustrates for display of assets related to an interaction with a first asset.

FIG. 6 is an example screenshot of a user creating assets for use as an advertisement.

FIG. 7 is an example screenshot of a user completing the creation of assets for use as an advertisement.

FIGS. 8A and 8B are example screenshots of a user interacting with an advertisement in a first example.

FIGS. 9A and 9B are example screenshots of a user interacting with an advertisement in a second example.

FIGS. 10A and 10B are example screenshots of suggested actions presented to a user.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

As further described herein, a system (and method) is configured to share assets across applications. An application is any software with which a user interacts. Examples of applications include, but are not limited to, games, which may be stored wholly on the internet, wholly on the user's local computer or some combination thereof; media players; television programs which allow real-time interaction with viewers; websites, such as FACEBOOK™, MYSPACE™, and ORKUT™; email programs; word processors; video editing programs; live chat and messenger tools; web applications; paint programs; utilities and spreadsheets. An asset is something of use to a user in an application and across applications where the multiple applications can be distinct and/or disparate. Classes of assets include a procedure, an item, a modifier, an identity, an event, a piece of media, and logic.

A procedure is something that is executed; a particular course or mode of action; the sequence of actions or instructions to be followed in solving a problem or accomplishing a task. Types of procedure assets include, but are not limited to, an action or a program to be run, such as “delete” a paragraph or item from a friend's application, or “create a copy” of this paragraph or item in an application or a combination or sequence thereof, such as “steal” which would do both “create a copy” and “delete” from a friend simultaneously. Examples of items include a “house” in a game with houses, a “game” in a system featuring games, and a “sword” in a game involving a battle.

A modifier is an adjuster that can alter how an instruction is carried out or what happens to a piece of data as it is transferred from the source to its destination. Modifiers are often simple in their nature—such as multiplying an output value by a certain factor or changing various attributes of an item, identity, event, or object. Types of modifier assets include, but are not limited to, a skill like “faster” for a character or a qualifier such as “not stealable” for an object or item, “two days later” for an event or “compressed” for a media object like a picture.

An identity describes the property of objects that distinguishes them from other objects, without necessarily revealing all their internal values, therefore making them addressable within a system and types of identity assets include a person or a character. A user's friends are also identity assets.

Media is expression fixed in some way and examples include a video, picture, model, animation, text, graphics or a sound.

Logic is a declarative, representational language and model-generator used to solve problems or achieve goals and examples include a condition such as “if friend steals from me” or rule “friends can never steal from strangers.”

Events are a synchronization mechanism that are used to indicate to processes or users when a particular condition has become true. Events include actions that initiate outside the scope of a program that may be handled by a piece of code inside the program or reacted to by actors (users) and examples include notifications, occurrences and opportunities such as “friend using MS Word,” “friend entered your lair,” “Character died,” “Store open,” “You leveled up,” and mechanical timers “game over” or “auction complete.”

Asset types as well as individual assets are created by the operator of the asset server (“system assets”) but assets may also be created by users of the asset server (“user assets”) and developers of applications that use the asset server (“application assets”).

The described system (and method) allows users to not only interact with other users currently in other applications but also allows assets that a user has in one application to be used in other applications. In one example, the persona created by a user for a game is an identity asset and a user can transfer that persona to a second game. In another example, a skill at the user's disposal in a game is a modifier asset. That skill can be used in a second game. In another example, saving a document is an action asset in Microsoft Word. A user could use the save action in a game.

### System Architecture

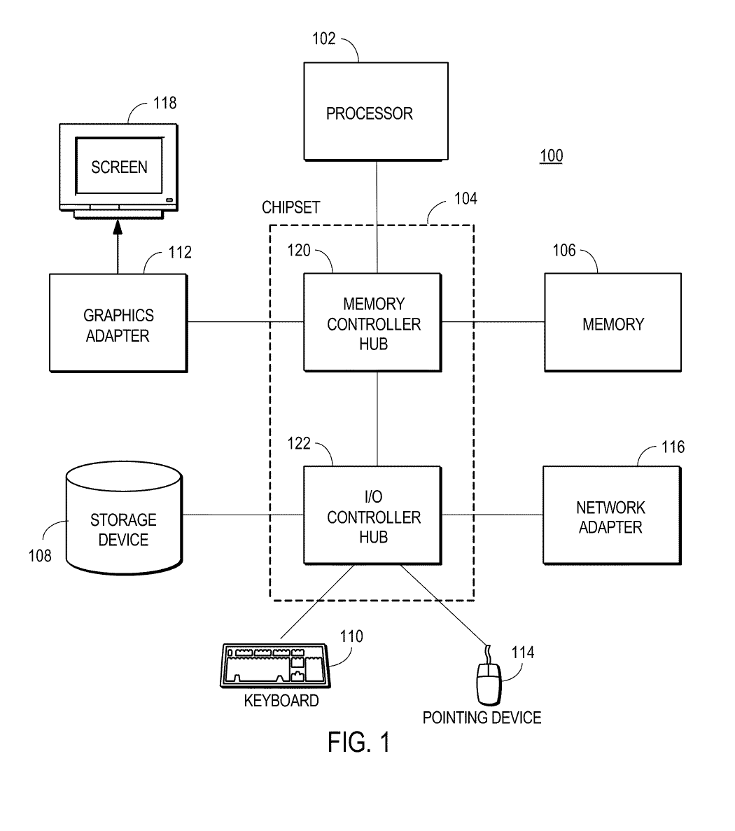

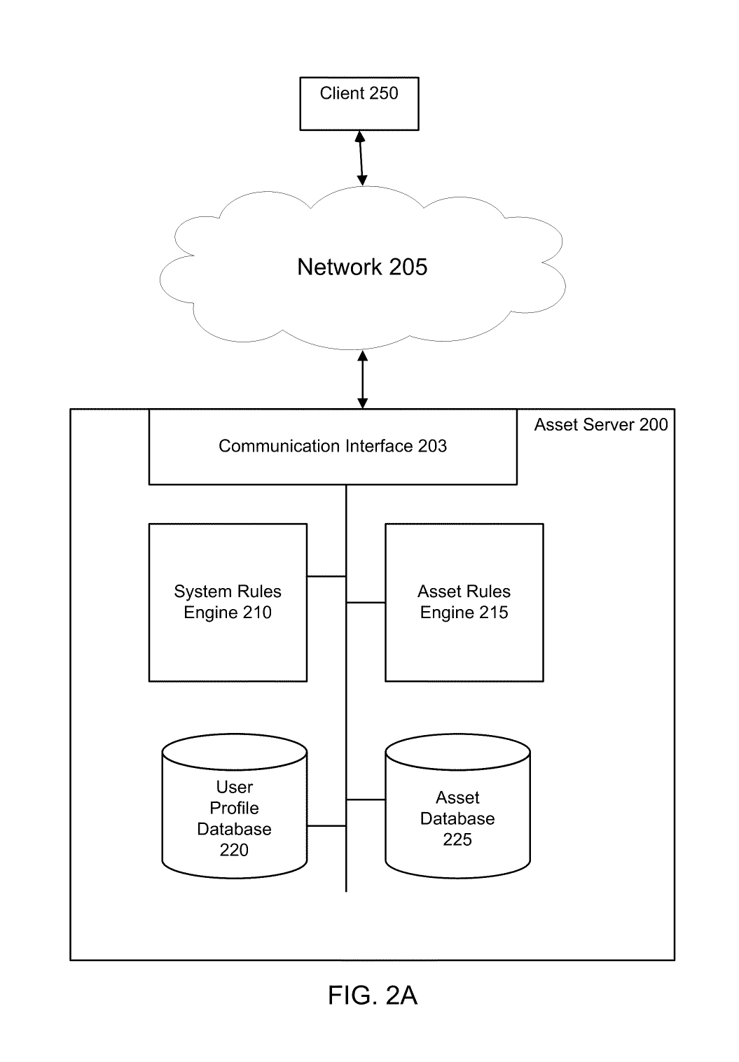

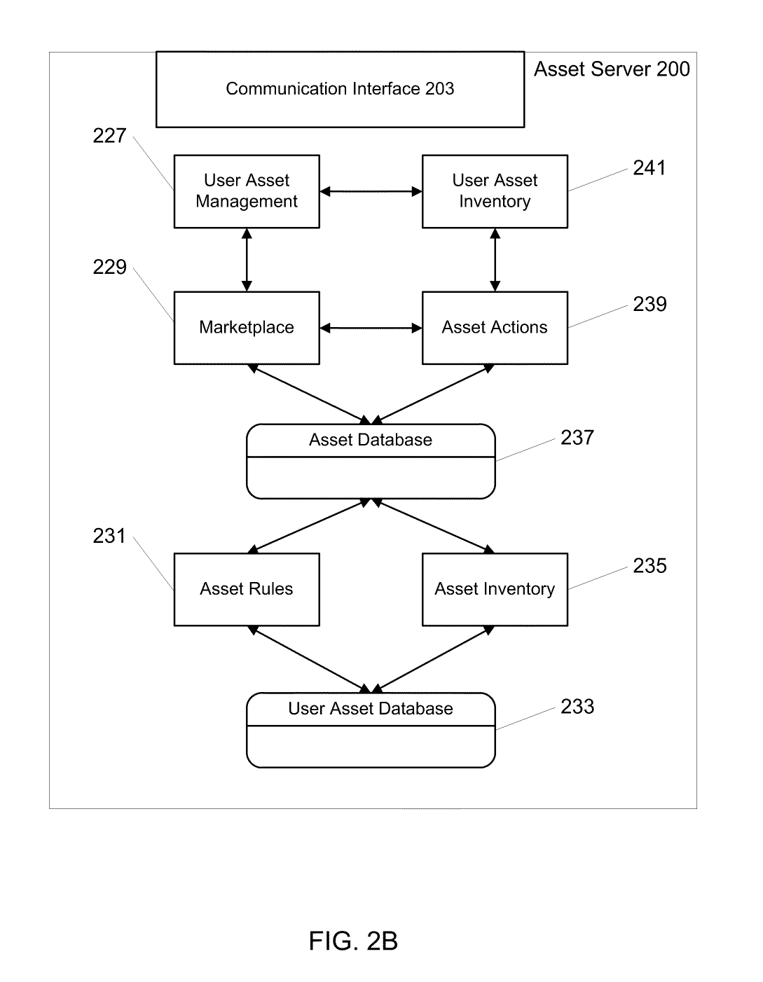

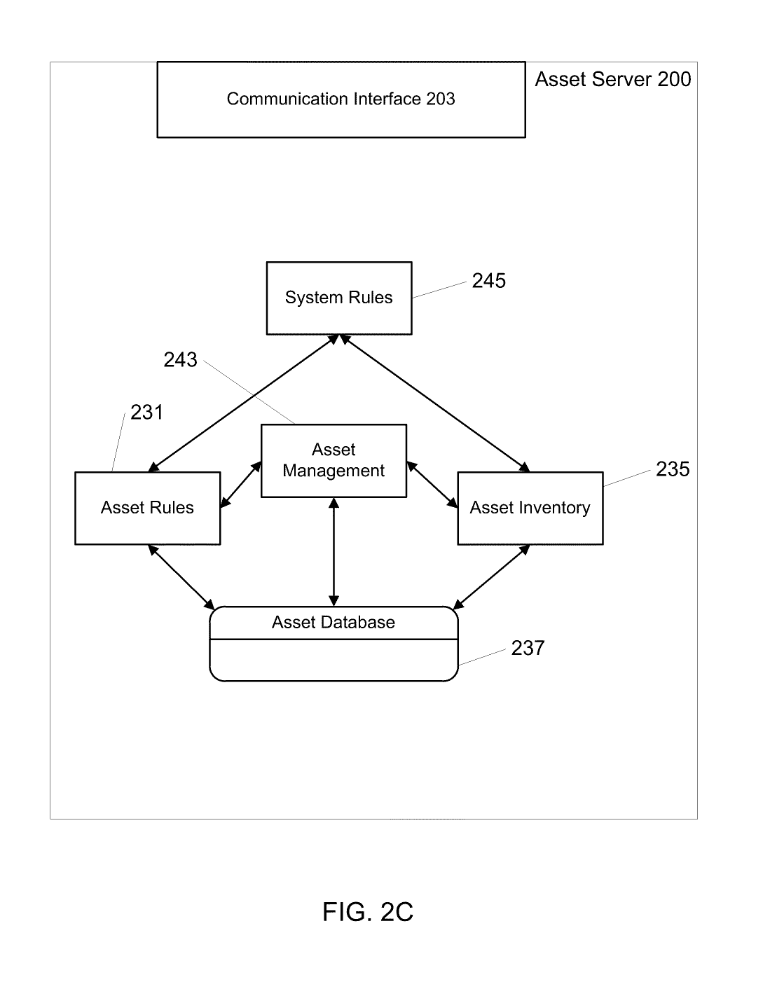

FIG. 1 illustrates one embodiment of a computer (or computer system) 100 configured for operation, e.g. in FIGS. 2 to 9, as further described herein. Illustrated are at least one processor 102 coupled to a chipset 104. Also coupled to the chipset 104 are a memory 106, a storage device 108, a keyboard 110, a graphics adapter 112, a pointing device 114, and a network adapter 116. A display 118 is coupled to the graphics adapter 112. In one embodiment, the functionality of the chipset 104 is provided by a memory controller hub 120 and an I/O controller hub 122. In another embodiment, the memory 106 is coupled directly to the processor 102 instead of the chipset 104.

The storage device 108 is any device capable of holding data, like a hard drive, compact disk read-only memory (CD-ROM), DVD, or a solid-state memory device. The memory 106 holds instructions and data used by the processor 102. The pointing device 114 may be a mouse, track ball, or other type of pointing device, and is used in combination with the keyboard 110 to input data into the computer system 100. The graphics adapter 112 is configured to provide for display on a screen (or display) 118 images and other information. The network adapter 116 couples the computer system 100 to a local or wide area network.

As is known in the art, a computer 100 can have different and/or other components than those shown in FIG. 1. In addition, the computer 100 can lack certain illustrated components. In one embodiment, a computer 100 lacks a keyboard 110, pointing device 114, graphics adapter 112, and/or screen 118. Moreover, the storage device 108 can be local and/or remote from the computer 100 (such as embodied within a storage area network (SAN)).

It is noted that computer 100 may also refer to a configuration having more than one physical computer, each of which is communicatively coupled together to form a logical computer configuration. The computers themselves may have generally high performance CPUs, with 1 G or more of memory, and 100 G or more of disk storage. Of course, other types of computers can be used, and it is expected that as more powerful computers are developed in the future, they can be configured in accordance with the teachings here. The functionality implemented by any of the elements can be provided from computer program products that are stored in tangible computer readable storage mediums (e.g., RAM, hard disk, or optical/magnetic media), or by equivalent implementations in hardware and/or firmware.

As is known in the art, the computer 100 is adapted to execute computer program engines (or modules) for providing functionality described herein. As used herein, the term “engine” refers to computer program logic utilized to provide the specified functionality. Thus, an engine can be implemented in hardware, firmware, and/or software. In one embodiment, program engines, such as a system rules engine 205 and an asset rules engine 210, further described with FIG. 2, are stored on the storage device 108, loaded into the memory 106, and executed by the processor 102.

Embodiments of the entities described herein can include other and/or different engines than the ones described here. In addition, the functionality attributed to the engines can be performed by other or different engines in other embodiments. Moreover, this description occasionally omits the term “engine” for purposes of clarity and convenience.

FIG. 2A is a depiction of the system architecture according to one embodiment. The system comprises an asset server 200 and client 250 which communicate via a network 205. The asset server 200 comprises a communication interface 203, system rules engine 210, asset rules engine 215, user profile database 220 and an asset database 225. For simplicity, only one asset server 200, communication interface 203, system rules engine 210, asset rules engine 215, user profile database 220 and asset database 225 are shown In practice the functions many of each of these components can be in operation.

The asset server 200 is implemented as server program executing on one or more server-class computers, such as the one illustrated and described with respect to FIG. 1. For example the system rules engine 210 and asset rules engine 215 may be configured as software instructions (a module) stored in the storage device 108 and/or the memory 106 and executable by the processor 102. Likewise, the user profile database 220 and asset database 225 may be configured for storage within the storage device 108 and associated software instructions are executable by the processor 102. Alternatively, the asset server 200 can be implemented in dedicated hardware, using custom designed circuitry to implement the logic of the operations described herein. The asset server 200 communicates with the client 250 via the communication interface 203. The communication interface 203 is, for example, an application programming interface, which is known in the art. It is noted that references to programs herein include software comprising instructions that are stored in a storage device, e.g., storage device 108, and/or memory, e.g., the memory 106, and executable by a processor, e.g., the processor 102.

The asset database 225 stores the assets and the assets' attributes. Attributes include aspects of how the asset is displayed such as asset-related images and asset names and descriptions; transactions available to be done to or with the asset such as buy, delete, duplicate, send, store, sell, trade; manipulations of the asset such as merging different assets together to form a new asset, adding application specific rules or changing some options to fit the application's context; user actions such as actions that can affect other users in the current application; and social interactions such as actions that can affect other users in other applications.

When an application developer makes an application (Game A) available for use with the present system, the developer provides the assets that will be shared to the asset server 200. For each such asset, the type of asset is identified. If the type of asset is known in the asset database 225, it is classified as belonging to that type. Alternatively, if the type of asset is not already in the asset database 225, the developer creates a new asset type. For example, if Game A uses t-shirts as assets and the t-shirt asset is already known in the asset database 225, the developer identifies the t-shirts from Game A as t-shirt assets to the asset database 225. Then in processing transactions, the asset server 200 applies the same system rules to the t-shirts from Game A as other t-shirts. The developer can still make additional rules that are specific to t-shirt assets originating from Game A if wanted or needed. And as will be discussed later, individual users can make rules specific to their own t-shirt assets.

When a developer provides assets to the asset server 200, standards for how the asset is displayed are also provided including, for example, character limits on titles and descriptions; sizes for the images (for example minimum and maximum number of pixels for the height and width of the image) and file size limits. Additionally, attachments can be included in the assets a developer provides to the asset server 200. Examples of attachments include audio files, video files, image files, documents and links. Individual users can also add attachments to their assets.

The rules that govern an asset are one type of attribute. The rules that govern an asset have various sources depending on the class and type of asset. A system asset is governed by system rules. An application asset is governed by system rules and the asset rules that were created by the application developer. A user asset is additionally governed by asset rules created by the user. Finally, system assets and applications assets belonging to a user can be subject to rules created by the user provided that the system rules and application developer's rules allow for a user to create rules for that asset. With the exception of the user-created rules for system and application assets, the rules that apply to an asset are either stored directly in the asset database 225 or a reference to the rule's location is stored in the asset database 225. The user-created rules for system and application assets are stored in the user profile database as described hereafter.

The user profile database 220 stores user profiles for users of the asset server 200. Included in the stored user profiles are the assets that are currently available to the user. These can be stored as the actual assets or as references to the asset located in the asset database 225. The user profile also includes any rules that are specific to the combination of an asset and a user. The user may have a t-shirt as an asset and the user can set a rule that the t-shirt cannot be stolen by any other users. This user- and asset-specific rule is stored with the asset in the user's profile. The user profile also includes identifiers for other users with whom the user associates in various applications. An example includes other users specifically designate as “friends” in an application.

The system rules engine 210 applies system-wide rules to requests received at the asset server related to assets. Examples of requests related to assets include a request from a client 250 to display assets available to the user and a request from a user to acquire an asset, deploy an asset or combine assets. The system rules include rules that govern processing of requests, rules that are associated with individual system assets, rules that govern the combination of assets as well as rules that govern the sale and trading of assets.

The asset rules engine 215 applies asset rules in the responding to requests. Asset-specific rules include those that apply to all instances of a certain asset—such as all t-shirt assets. Asset-specific rules are also rules that are specific to a user and an asset—such as the t-shirt that belongs to user Jane. Asset-specific rules govern all aspects of the use of the asset including, but not limited to, trading, playing, and selling of the asset. Should an asset-specific rule conflict with a system rule, the system rules engine 210 decides the conflict. In one embodiment, the system rule trumps the asset-specific rule.

The client 250 is a computing device, for example, operationally such as computer 100. The client 250 is any computing device capable of accessing the network, including mobile computing devices, known in the art, for example, general purpose computers, handheld mobile devices, internet-enabled televisions, cable or satellite set top boxes and video game consoles which have been adapted to provide the structures and functions described herein. A video game console is a computer that has been configured for running a video game. The client 250 may be configured similar to the computing device shown and described with respect to FIG. 1. For simplicity and ease of discussion, only one client 250 is shown. It is noted however, that the disclosed configuration functions with very large numbers (e.g., millions) of clients 250, or as many as can be supported by the hardware and software implementation, can be in communication with the asset server 200.

The network 205 is any local or wide area network, wired or wireless. Examples of a network 205 include, for example, the Internet, an intranet, or a personal area network.

FIG. 2B is a view of the asset server 200 components related to user management of assets according to one embodiment. Requests by users related to the management of their assets are handled by a user asset management engine 227. Requests include updating the asset, deleting the asset, or renaming the asset. The user's assets are managed through the user asset inventory 241, where the user can list their inventory and filter their inventory. The marketplace engine 229 handles transactions of assets including buying, selling and trading of user assets. The actions attributed to each asset are managed through the asset actions management 239, where additional actions can be added to an asset to give it unique characteristics.

To propagate changes made through the user's asset inventory 241, user asset management engine 227, asset actions database 239, or market place engine 229, changes are validated by the asset database 237, which consults asset rules database 231 and asset inventory 235 to do the validation, before saving to the user asset database 233 and updating all other fields accordingly.

Performed actions are synchronized through the user asset database 233. However before doing so, the asset database 237 is consulted to ensure that the action complies with the asset's rules and inventory.

FIG. 2C is a view of the asset server 200 components related to developer management of assets according to one embodiment. Managing assets will update the entire system, but will also be dependent on system rules 245. When assets are managed 243 inventory 235 and asset rules 231 are updated. Once they pass these steps, the asset is stored in the databases 237. When the API (communication interface 203) calls for an asset, it will check through the system rules 245 and if it passes it can retrieve the asset from inventory 235 according to the asset rules 231 and then return the data back to the API (communication interface 203) to be executed upon. When a request is made to the API (communication interface 203), the first action will be to determine whether the system will allow the request which involves consulting the system rules 245. Then it is determined whether the asset rules 231 and asset inventory 235 permit further action on the asset. Once validated, the asset database 237 can be called to retrieve asset specific information like asset rules 231 and complete information on the asset's inventory 235.

### Use Case

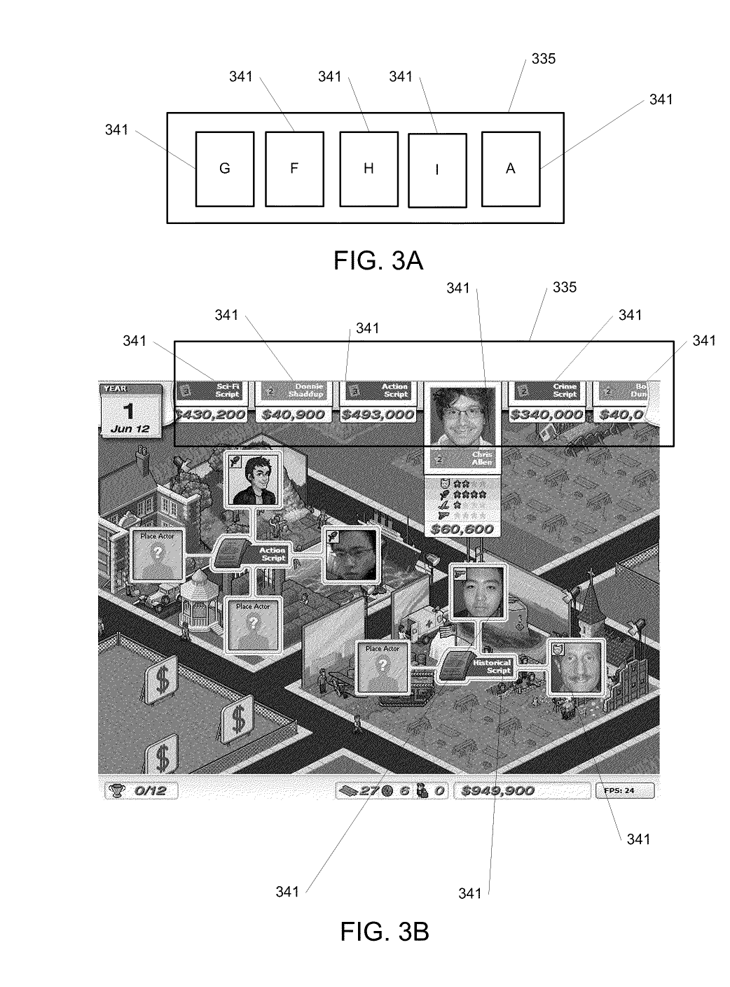

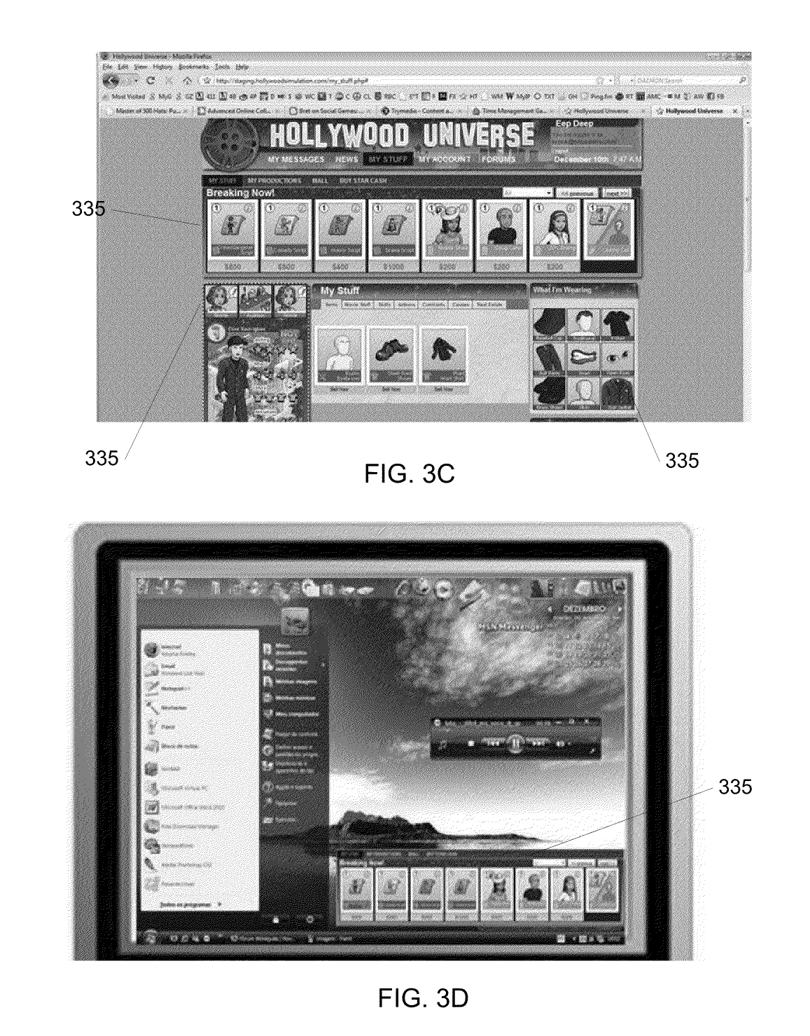

The system (and method) is now described further while describing its operation. In this example, a user is playing a web-based game at the client 250. Referring to FIG. 3A, the display at the client 250 includes a display container 335 which includes assets 341 available to the user. FIGS. 3B-3D illustrate various embodiments of display containers 335. FIG. 3B illustrates assets 341 are displayed like trading cards both in a display container 335 and throughout the application, a game in this case. FIG. 3C illustrates a web application with multiple possible display containers 335 for assets 341. FIG. 3D illustrates a display container 335 for assets as a widget for an operating system and displayed on the desktop of the client 250 independent of any application.

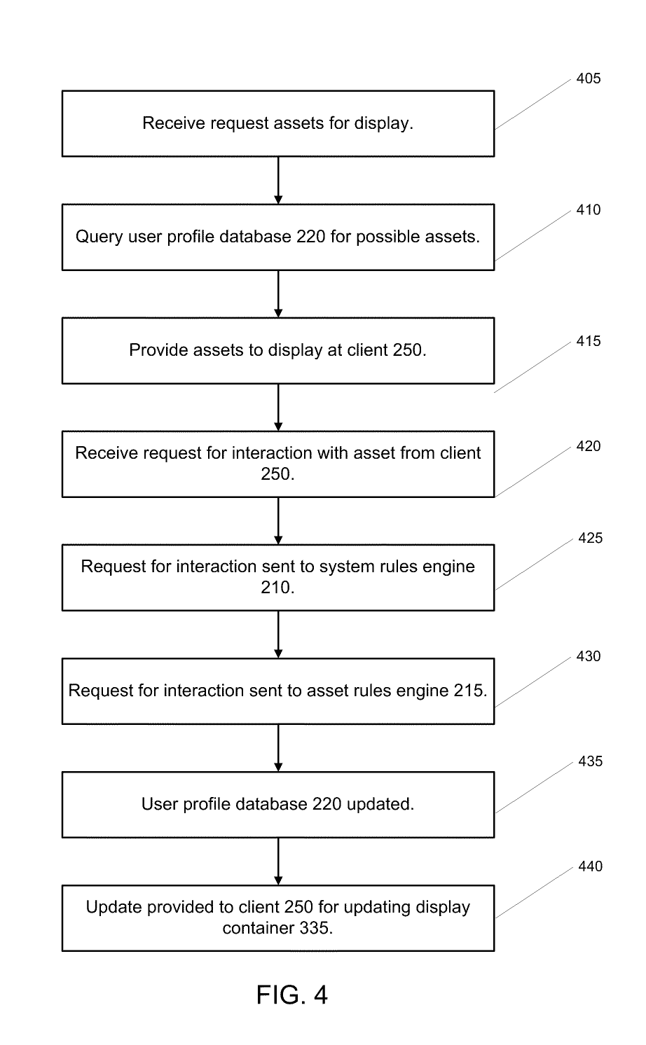

Referring to FIG. 4, which assets to display are determined by a request 405 from the game at the client 250 to the asset server 200 via the communication interface 203. The request received by the asset server 200 includes an identifier for the user and optionally identifiers for the application currently open at the client 250. The user profile database 220 is queried 410 for assets available to the user. In an embodiment where the display container 335 is part of an application open at the client 250, the assets 341 displayed in the display container 335 can be limited to the assets 341 that are available for use in that application. When the display container 335 is a stand-alone window or application, the displayed 341 include assets that may not be available for use in the application open at the client 250 or other applications that may be opened later at the client 250. The assets 341 to be provided for display are retrieved from the asset database 225 and transmitted to the client 250. The transmitted information about the assets to display may be formatted for example in XML, JSON or a flat file. The data may also be formatted in a system generated rendering layer, which may include formats like HTML, XHTML, or other interfacing standards. The attributes of the asset are included.

Available assets retrieved from the user profile database 220 include assets that belong to the user's friends but are available to the first user for interaction. In one example if a friend's asset is available for stealing, that asset is retrieved and displayed to the user in the display container 335.

In one embodiment, assets to be displayed in the display container 335 are too numerous to fit inside the display container 335. To still be able to display all assets to the user, the assets scroll through the display container 335. In some embodiments, some assets are displayed only for a given period of time—for example 30 minutes.

Optionally, the assets 341 displayed in the display container 335 are also stored in a cache at the asset server 200. As the user interacts with assets 341, the asset server 200 can react more quickly than if the user profile database 220 is updated continually and is queried every time an interaction is requested. Because one user can interact with another user's assets, a user's assets may be cached even while the user is not active on any application to allow for quicker interaction as other users interact with the inactive user's assets. In an embodiment using a cache, the system rules engine 210 first queries the cache when receiving a request to display assets. If the information in the cache is older than a threshold amount of time, for example 15 minutes, the system rules engine 210 proceeds as described previously. If the cached information is sufficiently recent, the system rules engine 210 returns the cached information to the client 250. The cache synchronizes with the user profile database 220 and asset database 225 at pre-determined intervals—for example every 15 minutes, every 130 minutes or every hour.

In an example interaction in the game, the user chooses to steal an asset from another user. The first user knows this asset exists because it is displayed to the first user in the display container 335 as an asset belonging to the second user that is available for stealing. The first uses selects the procedure asset, “steal” and the second user's asset to be stolen, a sword for example. Upon initiating the steal of the second user's asset, the client 250 at the first user initiates a call to the asset server 200. Referring again to FIG. 4, the asset server 200 receives 420 the request from the client 250 to complete the steal action. The system rules engine 210 receives 425 the request and applies relevant system rules. The asset rules engine 215 applies asset rules relevant to the requested interaction. One of the relevant asset rules includes confirming that the asset is still available for stealing. Upon determining that the asset is available for stealing, the asset server 200 executes the interaction and updates 435 the relevant user profiles to remove the sword from the second user's profile and add it to the first user's profile. In an embodiment, where users' assets are cached, the cache for each user's assets is updated and the relevant user profiles and asset database 225 are updated at a later time. An update is provided 440 to the client 250 for updating the display container 335 to add the stolen asset as now belonging to the first user. The second user's display container is also updated to remove the stolen asset. Optionally, a notification, in addition to just the removal of the asset, is provided to the second user that one of the user's assets has been stolen by the first user.

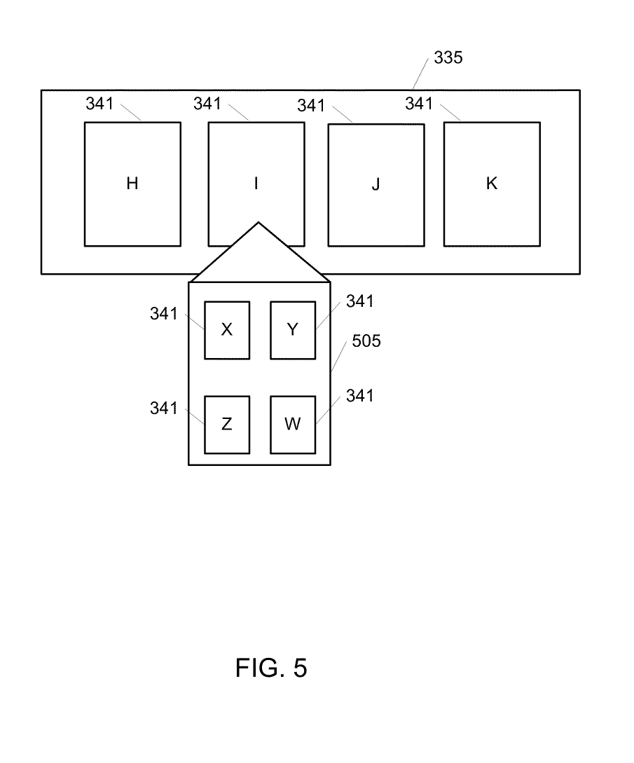

In another embodiment illustrated in FIG. 5, assets available for stealing are not shown in a user's main display container 335. Rather, upon a user selecting the “Steal” asset 341-I, a request is sent to the asset server 200 for assets that are available for the first user to steal. The system rules engine 210 processes the request by querying the user profile for assets available to steal. This is accomplished either by references to stealable assets stored in the user's profile or by querying the user profiles for the user's friends for stealable assets. The asset server 200 returns the stealable assets and they are displayed in a second display container 505. Should the user choose to steal an asset, the stealing action proceeds as described previously.

Another example interaction is the combination of assets. Users can create new assets that are combinations of existing assets to be used throughout the system or within specific applications or platforms. In order to avenge theft of an asset that may occur in the future, a user can create an asset that is a combination of a logic asset “If asset stolen” and a procedure “rain on thief.” The user sends the request to combine the assets into a new asset to the asset server 200 and the request will be processed as explained previously—system rules and asset rules will be applied and if the requested action satisfies the requirements, the user's profile will be updated to replace the individual assets with the new combined asset and the display container 335 will be updated accordingly as well. This particular new asset is self-deploying. Should the condition of an asset being stolen arise, the new asset will deploy and act on the thief of the asset. The deploying of that asset while not requiring the intervention of the user who created the asset will still proceed through the asset server 200 as any other request for an interaction.

### Example

### User Interaction Sharing of Assets

The following example refers to the system and method described herein and illustrated in the accompanying figures.

DRAMATICA PRO is an example application used by a user at the client 250. A first user writes a television script with DRAMATICA PRO and when it is saved, the user is prompted with a check-box: “Do you want to save a summary to see if anyone will make a promo trailer for you?” Choosing “Yes” results in the summary paragraph and title becoming an asset, “Script Summary,” represented as a card in the display container 335 such as, for example, those illustrated in FIGS. 3A-3D. The user chooses attributes for this new asset, “Script Summary” such as category of the script, “Comedy,” and rules such as the level of sharing as “Share Unconditional.” Other options for sharing include Share with Games, Share with Content Tools, Share in Markets, Share Only Unedited, etc. Script Summary with its accompanying attributes is stored in the asset database 225 and referenced in the user profile database 220 as associated with the user. Additionally, because the user has opened Script Summary to unconditional sharing, a reference to the asset will be stored in the user profiles for other users with whom the first user is a friend. Thus Script Summary will be available to those friends.

A second user is a user of APPLE IMOVIE, another application running on a client 250 and a user of the asset sharing method described herein. When the second user chooses the “Browse Ideas from Writers” action of IMOVIE, a display container 335, such as, for example, those illustrated in FIGS. 3A-3D, is presented with items which are movie scripts from various applications including DRAMATICA PRO. The display container 335 of movie scripts may be filtered and sorted according to any known method. Among the assets displayed is the movie script written by the first user, Script Summary. Upon interacting with one of the scripts, a second display container comprising cards of action assets is displayed to the IMOVIE user. In one embodiment the action assets made available to the user is determined by the application in which the assets are to be used.

One of the options displayed includes the action of making a promotional short for a script. Upon selection of that action, the IMOVIE application loads all of the information about Script Summary into IMOVIE's promotional short-making functionality even though the script was not necessarily created in IMOVIE. In one embodiment, Script Summary can only be used once and upon Script Summary being selected, it is marked as not available to other users of IMOVIE, DRAMATICA PRO and any other application through which a script asset is available. Alternatively, Script Summary may be used multiple times and it is not removed from availability upon being used once. The determination of whether or not Script Summary may be used more than once is made by the asset server 200 according to system rules and asset-specific rules associated with Script Summary.

Upon completing and saving the promotional short for Script Summary, the “Save” action is used and the “Clip” asset is created and is available for display in display containers 335. Upon creation, Clip is sent to the asset server 200 and stored in the asset database 225 along with its attributes. In one embodiment, Clip appears in the a display container 335 next to Script Summary or is in some other way designated as being associated with Script Summary.

The two assets, Script Summary and Clip may be combined using Combine which is an action asset. The result of combining the two is a new asset, “Movie Project” which is stored the asset database 225. Stored with Movie Project are its attributes including rules about in which applications Movie Project is available to users. In a game, for example, viewing an asset and rating is a way to earn points. If Movie Project is marked for sharing, it can be accessed by many users in this way. Each rating of Movie Project is added to the attributes for this asset and stored.

Another possible interaction with Movie Project would be in a game wherein users create movies by combining Identity assets with Movie Projects or with Script Summaries. Such an asset becomes Movie which may be shared as with other assets.

Assets include virtual money which may be earned by selling the assets such as Movie Project or Movie and then the money asset is also an asset that may be shared across applications.

### Example

### Assets as Advertisements

In one embodiment, an asset originating in an application is provided to users who are not users of the originating application to advertise that originating application and encourage the user to use that that application. In such an embodiment, developers of the application to be advertised can purchase assets to be displayed to users who currently are not users of that application.

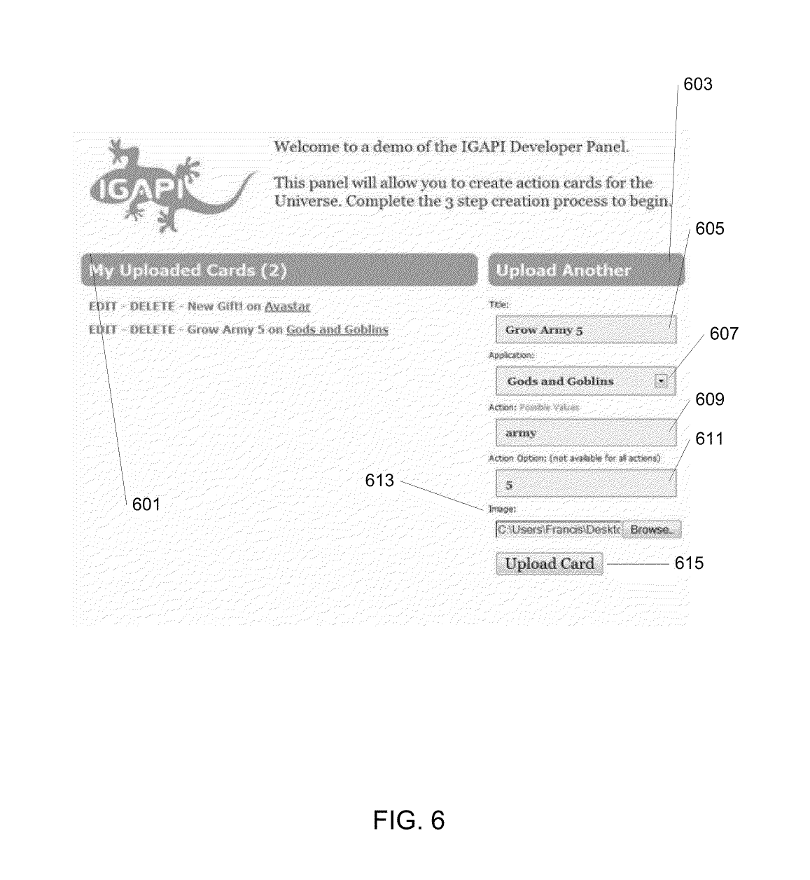

FIG. 6 illustrates a user interface as displayed to a developer of an application that allows that developer to create assets to be used as advertisements for the developer's application. Area 601 which shows the assets already created by the developer. In this embodiment, the assets are created as cards. A second area 603 where the developer creates new cards. In creating the card, the developer adds a title 605 for the new card. Additionally, the application 607 in which the asset by the card originates is specified. In this example, the card originates in the Gods and Goblins game. The asset represented by the card is specified in the action box 609. In this example, the asset is an army. For the asset, army, it is possible for the card to represent multiple armies and so the developer specifies how many armies in the action option 611. Should the developer choose to add an image to their card, that is uploaded at the image 613 box. Finally, selecting the Upload Card button 615 uploads the card.

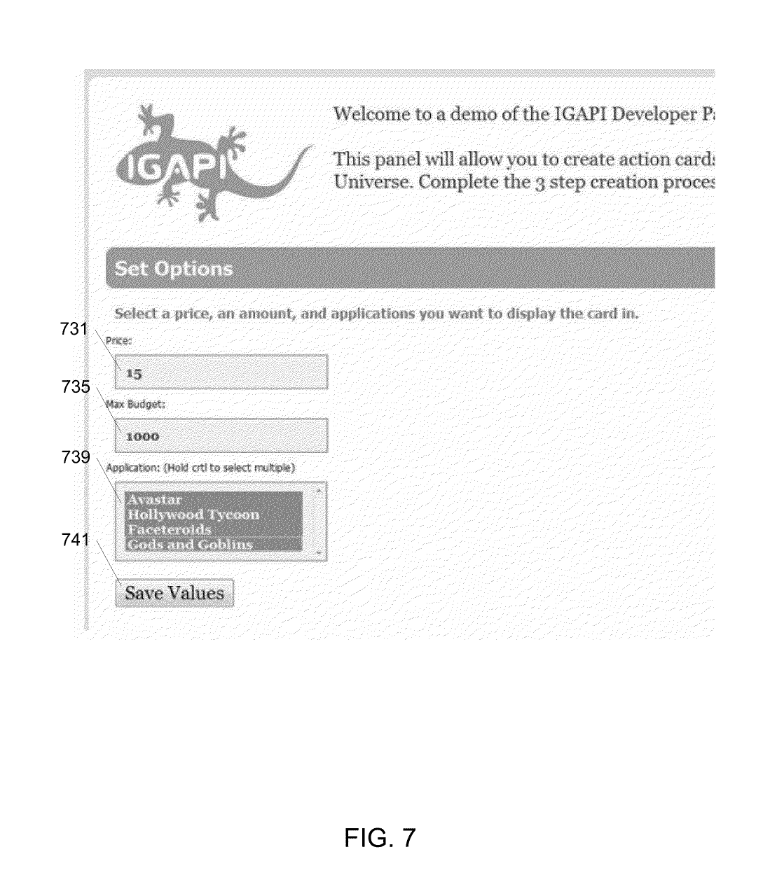

FIG. 7 continues the process. Box 731 displays the price to the developer each time the uploaded card is used. The developer enters his or her budget in the budget box 735 so that the system can calculate how many cards the developer is purchasing. Box 739 allows the developer to choose applications in which the card will be displayed. This means that the card representing five armies for use in Gods and Goblins will be available to be displayed to users not only of Gods and Goblins but also to users of Avastar, Hollywood Tycoon and Faceteroids. Selecting button 741 saves the values for the uploaded card.

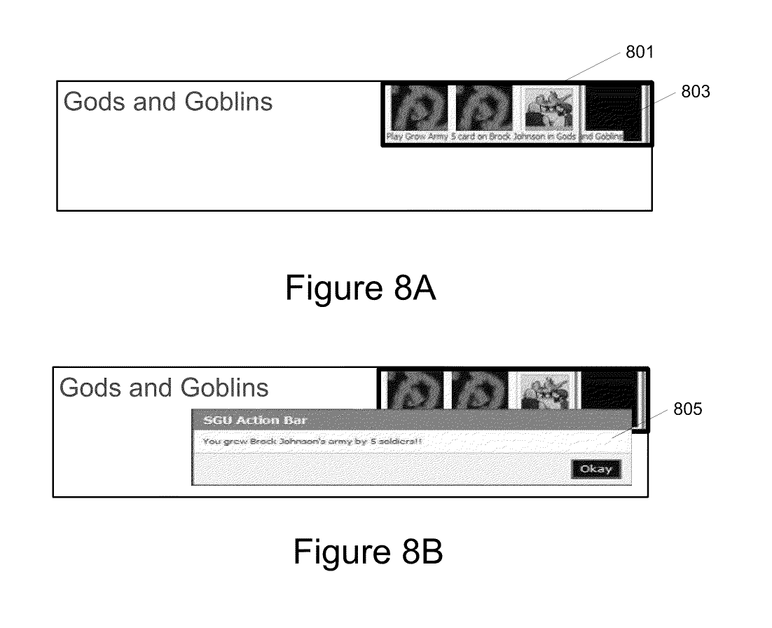

FIG. 8 illustrates a display of assets available to a user in the application, Gods and Goblins Container 801 displays assets available to the user. The right-most asset 803 is the action of giving Brock Johnson five armies in the game Gods and Goblins. This card 803 is a combination of one of the uploaded cards from FIG. 13 which gives five additional armies to a user and the fact that the user has a friend, Brock Johnson. Rather than the user of Gods and Goblins having a card to give someone five armies and then the user selecting to whom to give the five armies, the card presented to the user has pre-selected a friend to receive the five armies should the user decide to use the card.

Upon selecting the card 803, a request goes to the asset server 200 via the communication interface 203 and provided that system rules and asset rules are satisfied, the user profile for Brock Johnson is updated to add five armies to the assets. In one embodiment, the communication interface 203 is an API. The API makes a call to the Gods and Goblins API listener script. Upon Gods and Goblins performing the action of giving five armies to user Brock Johnson, it responds to the API that the action has been performed. The API in turn reports to the user (who coincidentally is also in Gods and Goblins) that the requested action has been performed. The user profile database 220 for user Brock Johnson is updated to indicate the five new assets. FIG. 8b illustrates a box 805 shown to the user confirming the action.

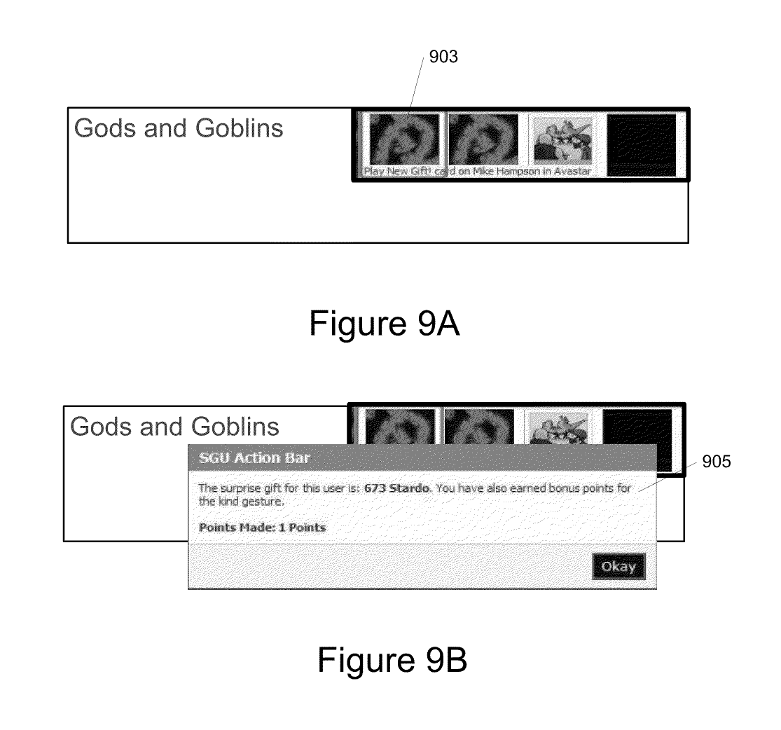

In a second example illustrated in FIG. 9A, the user is playing Gods and Goblins and chooses a card 903 which gives a gift to another user, Mike Hampson, in Avastar. Upon selecting that card, a call is made to the asset server 200 via an API and the API determines the location of Avastar's API listener script and relays the instruction to give a gift to Mike Hampson. After performing the action, Avastar API listener script replies to the API that the action has been completed and the API reports back to the user in Gods and Goblins that the requested action has been performed. FIG. 9B illustrates a box 905 shown to the user confirming the action. In this embodiment, the action also has an effect on the user doing the action because the user receives a point. This point is an asset that is added to the user's asset inventory.

An additional example would be a game which simulates a boat race, Yacht Cup. Players of Yacht Cup put together a crew and race against other players' boats. To advertise Yacht Cup, the developer creates an asset to be displayed to users who are not players of Yacht Cup but who are friends with or otherwise associated with users who are players of Yacht Cup. An example asset might be “Rain.” The asset “Rain” can be merged with a player of Yacht Cup and become “Rain on [User of Yacht Cup].” By using the asset, the non-player user interacts with another user who is a player of Yacht Cup and the non-player is introduced to Yacht Cup. In one embodiment, upon using the asset, the non-player is given the option to click through to the website for Yacht Cup. In order to drive more business to Yacht Cup, in one embodiment, the developer of Yacht Cup pays to have Yacht Cup-related assets displayed to users who are not players of Yacht Cup.

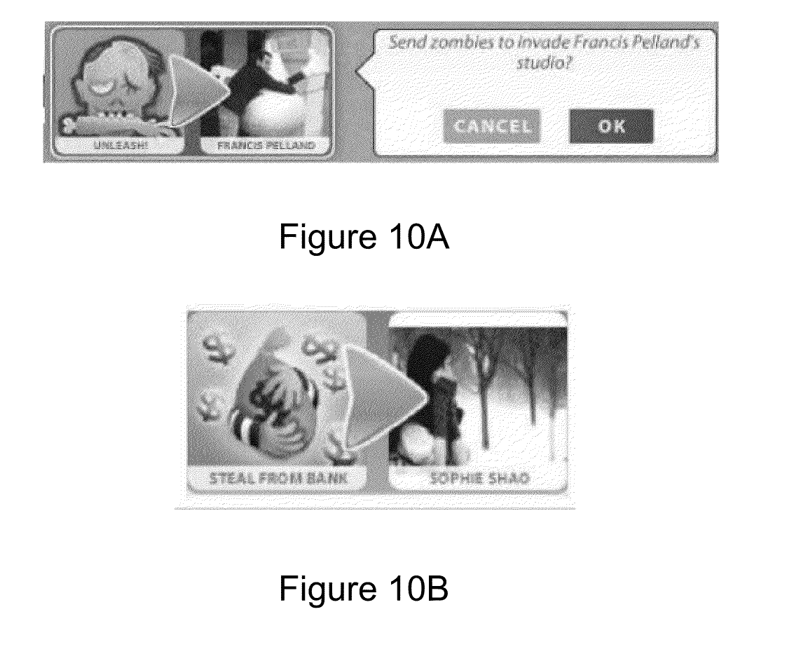

Advertising an application can also be directed towards existing users of an application. The described advertisements can also be displayed to users of the advertised games when they are playing another game in the display container 335 in their current game. This would be enticing them to come play the advertised game instead. Or if a user is not playing any games but has a stand alone display container 335 open on the desktop, the advertisement can be displayed to them enticing them to come play Yacht Cup. FIG. 10 shows example screenshots of such advertisements.

In an embodiment where certain assets are advertisements, the advertisement assets are selected for display to users according to the list of predefined rules. Such rules can be the frequency in which they visit related applications, friends who may be interacting with the user from that application, other users' actions performed from that application on the user, or the cost which the advertiser has chosen to pay.

Statistics including displays, purchases, and interactions are available for all assets uploaded to the system. Statistics may be used to charge publishers, control their asset impressions, manage applications where assets appear, or as analytics.

### Additional Considerations

Further, the features and advantages described in the specification provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or portions of components, e.g., server systems, to support their functionality are located locally or remotely relative to the user.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

In addition, some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as engines or code devices, without loss of generality.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative systems and methods for targeting content to users on the Internet using data captured by social media in accordance with the disclosed principles herein. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope of the disclosure and appended additional claimable subject matter.

What is claimed is:

1. A method performed on a computer for sharing assets across applications, the method comprising:
receiving a request from a user for an asset to be used in a first application, the asset associated with a second application;
responsive to the request, determining at least one rule associated with the asset, wherein the at least one rule comprises a rule for using the asset; and
responsive to the determined at least one rule and the request, providing the asset to the second application.

2. The method of claim 1 wherein the at least one rule is associated with at least one of the first or the second applications.

3. The method of claim 1 wherein the at least one rule is associated with the user.

4. The method of claim 1 wherein the asset is associated with a second user and the at least one rule is associated with the second user.

5. The method of claim 1 further comprising updating a user profile associated with the first user.

6. The method of claim 5 wherein the asset is associated with a second user and further comprising updating a user profile associated with the second user.

7. The method of claim 1 further comprising determining a type of the asset and wherein the at least one rule is further associated with the type of the asset.

8. A method performed on a computer providing assets to a plurality of applications, the method comprising:
receiving a request from a client device;
responsive to the request, determining a plurality of assets associated with a user wherein at least one of the plurality of assets is associated with a plurality of applications; and
providing the plurality of assets for display at the client device.

9. The method of claim 8 further comprising determining a rule associated with a second at least one of the plurality of assets wherein the rule comprises a rule for presenting the second at least one of the plurality of assets.

10. The method of claim 9 further comprising responsive to the rule, not presenting the second at least one of the plurality of assets.

11. A system for sharing assets across applications, the system comprising:
an interface configured to receive a request from a first user for an asset to be used in a first application, the asset associated with a second application;
a rules module configured to:
identify the asset,
determine at least one rule associated with the asset, and
apply the at least one rule to the request; and
a database configured to store a plurality of assets and at least one attribute associated with each of the plurality of assets.

12. The system of claim 11 wherein the at least one rule is associated with at least one of the first or the second applications.

13. The system of claim 11 wherein the at least one rule is associated with the first user.

14. The system of claim 11 wherein:
the rules module is further configured to identify a second user associated with the asset, and the at least one rule is associated with the second user.

15. The system of claim 11
further comprising a user profile database for storing profiles for a plurality of users wherein each of the profiles comprises at least one asset associated with the user associated with the profile; and
wherein the rules module is further configured to update the profile for the first user responsive to the request and the at least one rule.

16. The system of claim 15 wherein the rules module is further configured to determine a second user associated with the asset and update a user profile associated with the second user.

17. The system of claim 11 wherein the rules module is further configured to determine a type of the asset and wherein the at least one rule is further associated with the type of the asset.
